(19) United States
(12) Patent Application Publication
(10) Pub. No.: US 2005/0044394 A1
(43) Pub. Date: Feb. 24, 2005

(54) Method of the information secure

(76) Inventor: Wenhu Wang, Shanghai, (CN)

Correspondence Address: ARTHUR KING MA, 1030 CORONADO DRIVE, ARCADIA, CA, 91007, US

(21) Appl. No.: 10/495,005

(22) PCT Filed: Nov. 8, 2002
(86) PCT No.: PCT/CN02/00798

(30) Foreign Application Priority Data
Nov. 9, 2001 (CN) 01132166.0

(51) Int. Cl. H04L 9/00

(52) U.S. Cl. 713/200

(57) ABSTRACT

A process for securing information includes the steps of (1) reading an environment variable and a system variable of a program; (2) performing an operation on the environment variable and the system variable such that the obtained operation result thereof constitutes an indispensable variable or variables used to properly execute subsequent instructions of a program; and (3) executing the subsequent instructions of the program. The environment variable and the system variable function as a driving force for running the program and indispensable elements to ensure properly running of the program. The program employing the present process cannot be cracked by conventional hacking-through or circumventing methods. Security and reliability are then desirably enhanced.

### BACKGROUND OF THE INVENTION

1. Field of the Invention

The present invention generally relates to computer information security, particularly to a process for securing computer information for use in a computer software.

2. Description of Related Art

Problems of information security have been issued ever since the ancient. Before invention of computers, information security was closely related to politics and military affairs. Nowadays, information security has covered a wide range from nations, entities to individuals. Almost every aspect of modern life is affected. Additionally, computer crime is currently on the rise. It is becoming increasingly important to develop ways to protect information securely.

Even through information security is generally regarded as high technology, a securing process of the present and that of the ancient are substantially the same. With reference to FIG. 1, a process for securing computer information generally comprises the steps of:
step 101: reading a password,
step 102: reading a preset key,
step 103: comparing the password with the key, if the result of step 103 is true, going to step 104; and if the result of step 103 is false, going to step 105,
step 104: executing subsequent instructions, and
step 105: terminating execution of the subsequent instructions or going to a loop step.

Now a cryptographic process for securing information is selected to illustrate a conventional information security process.

I. Key

The term “key”, which is generally also known as “password”, “serial number” and so forth, is used as an identification code. With regard to cryptography, the term “key” represents an encryption key or a decryption key.

Encryption can be classified into three categories:
1. Hardware encryption
2. Software encryption
3. Human encryption

Hardware encryption uses a hardware for encryption, while software encryption uses a program to execute encryption. A key of human encryption is generally selected in light of identifiable individuality of end users, which may be:
1. Secret codes known by the end user, such as a serial number;
2. Stored in a private certificate such as a magnetic card, an integrated circuit card and so forth;
3. Based on personal physical characteristics such as fingerprint, voice, or iris pattern; and
4. Handwritten signatures (including static and dynamic signatures).

The above-mentioned personal characteristics have to be converted into computer-recognizable binary digits.

II. True-or-False Judgment

The true-or-false judgment comprises the steps of: reading a password from an end user, comparing the password with a preset key of a program, and returning a resultant value: true or false. Correspondingly, in a digitalized format, the resultant value can also be: “greater than”, “less than”, or “equal to”.

III. Statement Execution

In order to prevent unauthorized invasion, if the result of true-or-false judgment is a value of false, the following statements can be selected to execute:
1. Abort the program;
2. Goto a circle; or
3. Relaunch the program.

In order to provide a reliable information security method, it is necessary to understand the principle and means for program cracking. The principle and means for program cracking are mainly as follows:

1. Password Embezzlement

Some software application incorporates registration and licensing functionality for protecting the software from illegal use. Such software application generally creates serial number protected installation. However, such software application can be readily cracked by embezzlement and reproduction of a valid serial number.

2. Password Cracking

A cracker may search each word in a cracking dictionary for the correct password. The cracker may also be able to retrieve the password from the user computer's memory via Internet by means of a snooping technique.

3. Program Modification

In addition to the password embezzlement and password cracking techniques, crackers may often crack a program by directly modifying the program statements. Generally, the cracker first uncompiles the program and finds out the “true-or-false judgment” and “statement execution” sections of the program by means of static analysis and motion tracking techniques. The program is then cracked by modifying the corresponding program statements with machine code. An inform ation security section of a typical program in assembly language is illustrated as follows:

| | |
|---|---|
| CALL | read a password |
| CMP | compare the password with a preset key |
| JZ | If “True”, jump to an entry point for normally running |
| | subsequent instructions |
| JNZ | If “False”, jump to an entry point for abnormal termination |

If the instruction JZ is modified into an unconditional jump JMP, the program then runs the subsequent instructions as normal, regardless of true or false. Alternatively, if the instruction JNZ is modified into the instruction NOP for performing no operation, the program can be also readily cracked. The cracked program can run properly without the need to enter the password.

Another exemplary information security section of a typical program in assembly language is illustrated as follows:

| | |
|---|---|
| CALL | read a password |
| CMP | compare the password with a preset key |
| JNZ | If “False”, jump to an entry point for abnormal termination |
| JMP | If “True”, jump to an entry point for normally running |
| | subsequent instructions |

The program can be readily cracked by means of modifying the instruction JNZ into NOP.

Consequently, although an uncompiled program is very long, the program can, nevertheless be readily cracked as long as the cracker take enough time to find out the information security section thereof. Furthermore, some programs often contain some conditional statements such as “if incorrect entry for three times, the program terminates.” which unfortunately provide crackers a clue to find out the information security section so as to crack the program.

Practically, some guarding programs may be more complicated. The guarding program may contain a plurality of preset keys, such as a user name and a registration code. The passwords and the keys may be further re-encrypted. As an example, Microsoft Windows operation system allows a user to set a password. The password is stored in a file with the extension name of “pwl” (Password List). If a data in the pwl file accords with the correct password, an unauthorized user may boot a computer with a floppy disk, and embezzle the password from the pwl file. Even though the data in the pwl file is encrypted and thus is different from the original data, the resultant value of the basic logical judgment can be nothing but true or false, match or mismatch, valid or invalid.

Anti-cracking is not a new emerging issue, computer specialists have taken some anti-cracking measures to protect computer information. These measures can be classified into passive measures and active measures.

Passive measures include employing compressing applications, employing protection mode and so on. Active measures include anti-debug, jamming tracking and so on. However, all of these can only enhance difficulty to crack a program, none of them changes the conventional information security mechanism.

The above-described security sections of the programs in assembly language assembler are, in principle, similar to password protection employed in ancient military. A sentry generally posted at a given spot verifies a password of a passerby to prevent the passage of unauthorized persons. However, intruders can pass the spot by killing the sentry. Similarly, crackers can also crack the program by means of a hacking-through technique such as executing a CALL instruction, or a circumventing technique such as modifying the JUMP instruction or the interrupt vector table, without the need to know the key. Therefore, such program protection measures are incapable of radically prevent unauthorized use of the program, instead become potential security flaws of computer information security.

### SUMMARY OF THE INVENTION

In view of the above, an object of the present invention is to provide a reliable process for securing information, which is uncrackable by means of conventional hacking-through, circumventing techniques.

In order to achieve the object set forth above, there is provided a process for securing information. The process comprises the steps of:
(1) reading an environment variable (Ve) and a system variable (Vs);
(2) performing an operation on the environment variable and the system variable such that the obtained operation result thereof constitutes an indispensable variable or variables used to properly execute subsequent instructions of the program; and
(3) executing the subsequent instructions of the program with the indispensable variable or variables.

The operation can be an arithmetic operation, a logic operation or any other suitable combination thereof.

The system variable can be a preset data in the program, a data callable by the program, or any suitable combination thereof.

The system variable can be kept at a single location, or kept separately at a plurality of locations.

The operation result can be directly assigned to the indispensable variable or variables. Alternatively, the operation result can be first subject to operations or conversions and the result of the operations or conversions is then assigned to the indispensable variable or variables.

The operation result can be a single numeric value, a group of numeric values. Alternatively, if the operation result is a multi-digit number, the multi-digit number can be further divided into a plurality of numeric segments in correspondence to the indispensable variables.

The operation result can be a number or numbers, a character or characters, a name or names such as a filename.

It is an advantage of the process of securing information of the present invention that the Ve and the Vs are subject to an operation or operations and the operation result is assigned to the variable or variables to be called in a later step of the program without the need to involve a conventional true/false judgment step. Thus, the operation result constitutes an indispensable part to properly run the subsequent section of the program. Consequently, such program becomes uncrackable by conventional hacking-through or circumventing techniques.

It is another advantage of the process of securing information of the present invention that unauthorized use or running of the program results in a multiplicity of quantitative rather than qualitative results which causes it extremely difficult to be tracked by crackers.

It is further another advantage of the process of securing information of the present invention that the operation result lacks characteristics to be tracked by the crackers, therefore it is difficult to be modified by machine code. For instance, a difference of ten-digit numbers can result in ten billions of results, while the true-false judgment yields only two or three results which are prone to be tracked and thus be cracked.

It is still another advantage of the process of securing information of the present invention that the information security can be further enhanced by employing the inventive process in a parallel, serial or nesting manner.

Employing the process in a parallel manner means employing the process in a plurality of sections of a program. Employing the process in a serial manner means that if one section of a program is cracked, the other sections still work. Employing the process in a nesting manner means employing the process in a parallel and serial combining manner.

The present process can preferably be combined with a cryptography technique to establish a typical nesting securing process. For instance, an increased cracking difficulty can be achieved by setting an encryption/decryption key by means of a difference operation or performing a difference operation on the encryption/decryption key.

It is yet another advantage of the process of securing information of the present invention that the process can be practiced in combination with other information security process to increase reliability and flexibility. For instance, the inventive process can be used to authorize limited number of users.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic flow chart showing a conventional process for securing information;

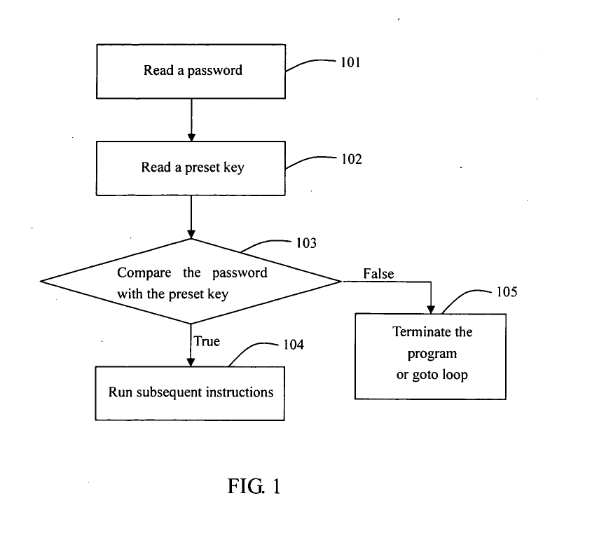

FIG. 2 is a schematic flow chart showing a process for securing information in accordance with the present invention;

FIG. 3 is a schematic flow chart showing a process for securing information in accordance with a first embodiment of the present invention;

FIG. 4 is a schematic flow chart showing a process for securing information in accordance with a second embodiment of the present invention; and

FIG. 5 is a schematic flow chart showing a process for securing information in accordance with a third embodiment of the present invention.

### DETAILED DESCRIPTION OF EMBODIMENTS OF THE PRESENT INVENTION

Reference will now be made to the drawings to describe the embodiments of the present invention in detail.

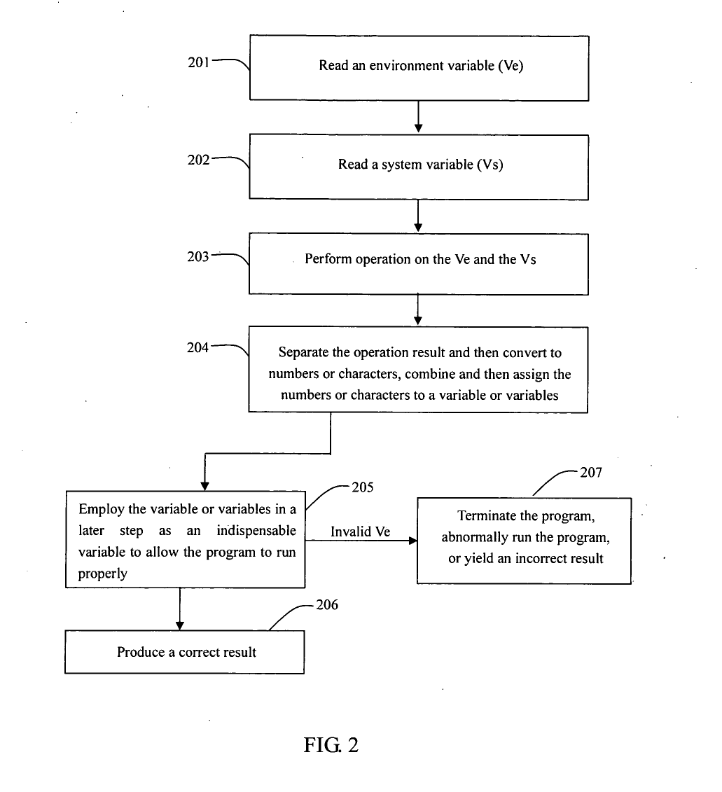

Referring to FIG. 2, a preferred process for securing information according to the present invention comprises the steps of: step 201: read an environment variable (Ve), step 202: reading a system variable (Vs) of a program, step 203: performing an operation on the Ve and the Vs, step 204: converting the operation result thereof into numeric value or characters and assigning the numeric value or characters to a variable or variables, step 205: taking the variable or variables as an indispensable variable or variables used to execute subsequent instructions of the program and executing the subsequent instructions of the program with the indispensable variable or variables, step 206: if the Ve is appropriate, executing the program normally and yielding a correct result; and step 207, if the Ve is inappropriate, running the program abnormally and yielding an incorrect result.

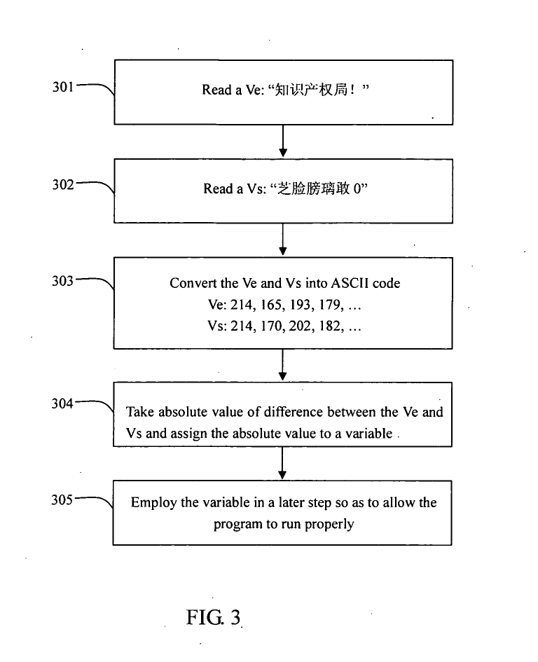

FIG. 3 illustrates a process for securing information in accordance with a first embodiment of the present invention. In the first embodiment, the Ve is a Chinese character string.

As is known, a volume label of a disk or a tape of a computer is accessible by a program, yet is uncopicable. In the present embodiment, the Ve is set to be a volume label “ [symbol] !”.

TABLE 1
Vs, Ve and Operation result

| | Vs in | | Ve in | |
|---|---|---|---|---|
| Vs | ASCII code | Ve | ASCII code | Difference |
| [symbol] | 214 | [symbol] | 214 | 0 |
| | 165 | | 170 | −5 |
| [symbol] | 193 | [symbol] | 202 | −9 |
| | 179 | | 182 | −3 |
| [symbol] | 176 | [symbol] | 178 | −2 |
| | 242 | | 250 | −8 |
| [symbol] | 193 | [symbol] | 200 | −7 |
| | 168 | | 168 | −1 |
| [symbol] | 184 | [symbol] | 190 | −6 |
| | 210 | | 214 | −4 |
| 0 | 79 | ! | 33 | +46 |

With reference to Table 1, the Ve is set to be “ [symbol] !”, and the Vs is set to be a character string “ [symbol] 0”. The Ve “ [symbol] !” and the Vs “ [symbol] 0” are converted to ASCII code according to GB 2132 (Chinese ideograms coded character set for information interchange). A value of the ASCII code of “ [symbol] !” is then subtracted from that of “ [symbol] 0”. The absolute values of the differences are decimal results “0, 5, 9, 3, 2, 8, 7, 1, 6, 4, 46”. Since the ASCII code 46 corresponds to character “.”, the ASCII code 46 is converted into a radix point “.”. Thus, the decimal results can be combined to constitute a single predetermined numeric value. The resultant numeric value is assigned to a variable to be used in a later step of the program. Consequently, the operation result of the Ve and the Vs becomes an indispensable part of the program.

For instance, assuming the program involves an area computation of a circle, the decimal operational results of Vs and Ve can be combined such that the obtained numeric value is just equal to PI which is namely the variable for use in calculation of the area of the circle. Even though an entered Ve is incorrect, the program remains to run but yields an incorrect result. The Ve and the Vs function as a driving force for running the program and indispensable parts to ensure properly running of the program. The inventive process therefore cannot be cracked by conventional hacking-through or circumventing methods. Moreover, a difference of ten-digit numbers can yield ten billions of operation results which lacks characteristics to be tracked by the crackers. Security and reliability thereof are therefore desirably enhanced.

FIG. 3 illustrates a process of securing information in accordance with a second embodiment of the present invention. The process comprises: step 301: reading a Ve “ [symbol] !”, step 302: reading a Vs “ [symbol] 5”, step 303: converting the Ve and the Vs into ASCII code, step 304: taking the absolute value of the difference between the Ve and the Vs to obtain a decimal result, and assigning the decimal result to a variable or variables, and step 305: employing the variable or variables in a later step of the program.

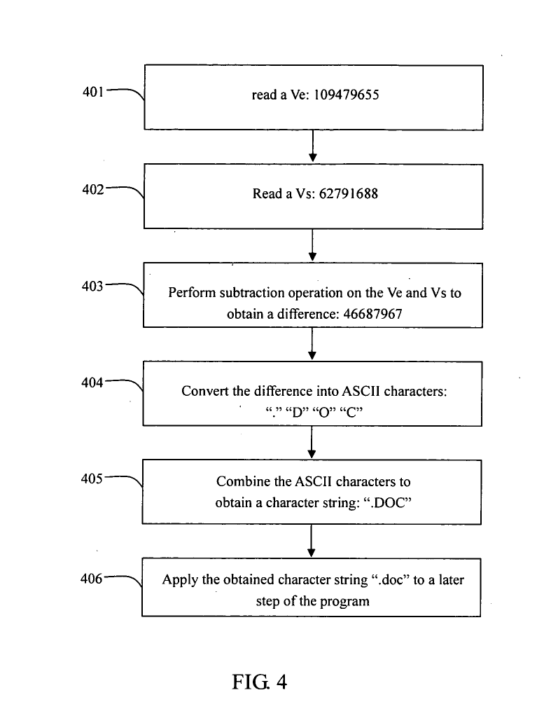

FIG. 4 illustrates a process for securing information in accordance with a second embodiment of the present invention. The operation result of the Ve and the Vs can be separated into a plurality of segments.

The process comprises step 401: setting a Ve to be “109479655”, step 402: reading a Vs “62791688”, step 403: performing subtraction on the Vs and the Vs, step 404: separating the result of step 403 into a plurality of numeric segments “46”, “68”, “79”, “67”, step 405: converting the numeric segments into ASCII characters “.” “D” “0” “C”, step 406: combining the ASCII characters to obtain a character string “.DOC”, and step 407: employing the character string “.DOC” in a later step of the program.

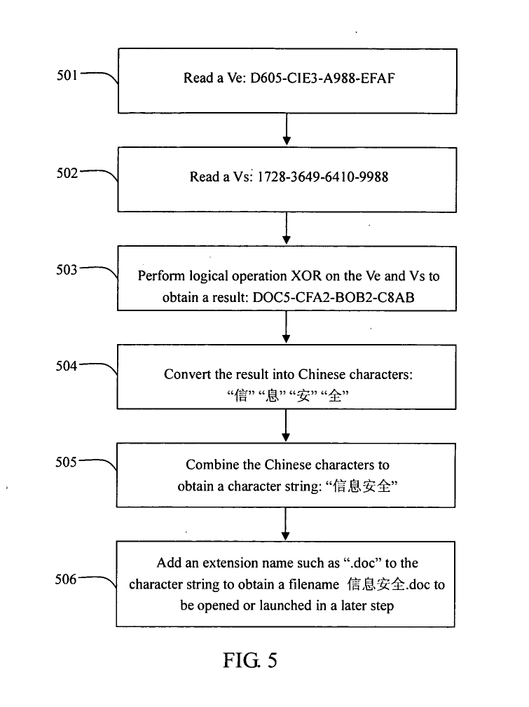

FIG. 5 illustrates a process of securing information in accordance with the third embodiment of the present invention. In the present embodiment, a result of a logic operation on a hex Ve and a dec Vs is converted into a Chinese character string “ [symbol] ”.

TABLE 2
Vs, Ve and Operation result

Operation Result

| | | | | ASCII |
|---|---|---|---|---|
| | Logic | | | Chinese |
| HEX Ve | operation | DEC Vs | HEX | characters |
| D605 | XOR | 1728 | DOC5 | [symbol] |
| CIE3 | XOR | 3649 | CFA2 | [symbol] |
| A9B8 | XOR | 6410 | B0B2 | [symbol] |
| EFAF | XOR | 9988 | C8AB | [symbol] |

The Ve and Vs comprise four numeric segments, respectively. The logic operation on the Ve and the Vs is an exclusive-or (XOR) operation. The hex then result is converted into Chinese characters. Afterwards, the Chinese characters are assigned to a character-string variable. The character-string variable is predeterminately set to be a name, such as a path name, a filename, a website, or even a command, to be employed in a later step of the program. In the present embodiment, the obtained character-string variable “ [symbol] .DOC” is a filename of a document which is to be called or launched in a later step of the program.

A program generally comprises a plurality of documents. The documents generally need to hook up with each other and may call each other. In the present embodiment, a correct Ve ensure a correct hook-up or calling relationship between the documents, while an incorrect Ve unavoidably yields a bad command or filename, thereby resulting in terminating the program or reaching an incorrect result.

The process of the third embodiment comprises: step 501: reading a Ve “D605, CIE3, A988, EFAF”, step 502: reading a Vs “1728, 3649, 6410, 9988”, step 503: performing an XOR operation on the Ve and the Vs to obtain the hex result “DOC5,CFA2,BOB2,C8AB”, step 504: converting the result into ASCII Chinese characters “ [symbol] ”, “ [symbol] ”, “ [symbol] ”, “ [symbol] ”, step 505: combining the Chinese characters to obtain a character string “ [symbol] ”, and step 506: adding an extension name, for instance “.DOC” to the character string to obtain a name of an existed file to be called in a later step.

It should be noted that the above-described preferred embodiments are exemplified herein for illustration purposes only, and are not intended to limit the present invention. A variety of conventional mechanisms are known to those skilled in the art, and may be suitably adopted, depending on different situation. Some directions are pointed out as follows:
1. Ve choosing criteria depends on requirements of information protection. In a first case, if a software program is installed on a computer and a reproduction thereof is not allowed to be installed on other computers, the Ve is preferably selected in light of hardware information such as characteristics of a motherboard, a CPU, or a hard disk of the computer. In a second case, if a software program is authorized to a single user, the Ve is preferably selected by the human encryption method. In the both cases, the Ve is preferably selected in light of the characteristics of both the hardware and human information.
2. In order to make the Ve and the Vs match with each other, the resultant numeral or character string should be capable of allowing the subsequent section of the program to run properly and reach a correct result. The Vs can be deduced according to the Ve, the operation to be performed, and the operation result to be predeterminately employed in the later step of the program. The obtained Vs is then written into the system during the first time installation of the program.
3. If the Ve or Vs is set with characters, the Ve or the Vs in ASCII code is preferably less than 32. The Ve or the Vs is preferable selected from double-byte characters such as Chinese characters rather than single-byte characters such as alphabetic characters.
4. How to read and write the Vs depends on particular program design. Preferably, the Vs is kept in a plurality of separate locations rather than in one locations.
5. Similarly, selection of the environment variable is associated with program design and hardware configurations. Preferably, the environment variable is unchangeable or irreproducible, and user-friendly.
6. The present invention is not intended to replace the conventional encryption-decryption methods, but to provide a method for preventing conventional cracking techniques so as to obtain a secure information protection.

While the preferred embodiment in accordance with the present invention has been shown and described, equivalent modifications and changes known to persons skilled in the art according to the spirit of the present invention are considered to be within the scope of the present invention as defined in the appended claims.

1. A process for securing information comprising:
(1) reading an environment variable and a system variable of a program;
(2) running subsequent instructions of the program according to an operation result of the environment variable and the system variable; wherein step (b) comprising the steps of
(1) performing an operation on the environment variable and the system variable such that the obtained operation result thereof constitutes an indispensable variable or variables used to properly execute subsequent instructions of a program; and
(2) executing the subsequent instructions of the program.

2. The process as described in claim 1, wherein the operation is an arithmetic operation, a logic operation or a combination thereof.

3. The process as described in claim 1 or 2, wherein the system variable is a preset data to be used by the program, a data callable by the program, or a combination thereof.

4. The process as described in claim 1 or 2, wherein the system variable is kept at a single location, or kept separately at a plurality of locations.

5. The process as described in claim 3, wherein the system variable is kept at a single location, or kept separately at a plurality of locations.

6. The process as described in claim 1, wherein the operation result is directly assigned to the indispensable variable or variables, or the operation result is subject to an operation or a conversion and the result thereof is then assigned to the indispensable variable or variables.

7. The process as described in claim 1 or 6, wherein the operation result is a single numeric value, a group of numeric values, or, a multi-digit number to be divided into a plurality of segments acting as a plurality of operation results.

8. The process as described in claim 1 or 6, wherein the operation result is a number or numbers, a character or characters, a name or names.

9. The process as described in claim 7, wherein the operation result is a number or numbers, a character or characters, a name or names.
